(19) United States
(12) Patent Application Publication
(10) Pub. No.: US 2020/0073100 A1
(43) Pub. Date: Mar. 5, 2020

(54) OPTICAL INTERFACES AND METHODS FOR RAPID VOLUMETRIC NEURAL MODULATION AND SENSING

(71) Applicant: The Regents of the University of Colorado, a body corporate, Denver, CO (US)

(72) Inventors: Emily A. Gibson, Boulder, CO (US); Cristin Welle, Boulder, CO (US); Diego Restrepo, Littleton, CO (US); Douglas Shepherd, Denver, CO (US); Juliet T. Gopinath, Boulder, CO (US); Victor M. Bright, Boulder, CO (US); Robert H. Cormack, Erie, CO (US); loannis Kymissis, New York, NY (US)

(21) Appl. No.: 16/557,935

(22) Filed: Aug. 30, 2019

Related U.S. Application Data
(60) Provisional application No. 62/724,793, filed on Aug. 30, 2018.

(51) Int. Cl. G02B 21/00; G02B 27/02

(52) U.S. Cl. CPC G02B 21/006; G02B 21/0076; G02B 27/02; G02B 21/0032; G02B 21/0036

(57) ABSTRACT

The present disclosure provides methods and systems for modulation and imaging of tissue. Various embodiments relate to optical interfaces and methods for rapid volumetric neural sensing and modulation, using structured illumination and

### CROSS-REFERENCE TO RELATED APPLICATIONS

This application claims the benefit of priority of U.S. Provisional Patent Application No. 62/724,793, filed Aug. 30, 2018, which is hereby incorporated herein by reference (including all appendices) in its entirety for all purposes.

### STATEMENT REGARDING FEDERALLY SPONSORED RESEARCH OR DEVELOPMENT

This invention was made with government support under grant number EY029458 awarded by the National Institutes of Health. The government has certain rights in the invention.

### BACKGROUND OF THE DISCLOSURE

### 1. Field

Various embodiments of the present technology generally relate to imaging technologies. More specifically, various embodiments of the present technology relate to optical interfaces and methods for rapid volumetric neural sensing and modulation.

### 2. Technical Background

Optical imaging of neural populations allows for simultaneous high-fidelity measurements of spatial and temporal dynamics of functional activity. Through combination with optogenetics, optical approaches also provide spatiotemporally defined activation of single neurons. Implementation of optical approaches has the potential to create highly detailed measurement and modulation of local neural population ensembles, and to allow for closed loop modulation at the single neuron level. Obtaining this level of fidelity in circuit observation and manipulation can give insight into critical brain functions, including those that underlie behavior, cognition, learning and memory.

Current state-of-the-art high-density neural interface solutions include both electrical and optical transducers. The lone high-density cortical sampling electrode that is FDA approved for use in humans and widely used in research, the Blackrock array, has several technological shortcomings. For example, the electrodes are situated at a fixed location within tissue and elicit an undesirably robust neuroinflammatory response, recording capability fails over time, and electrical stimulation by microelectrode arrays indiscriminately affects all local neurons and axons of passage. Thus, optical interfaces are an attractive alternative. However, light penetration is limited by light scattering and awake-behaving imaging systems utilize wide-field light for optogenetic stimulation, limiting specificity. Typical multielectrode arrays record from tens to thousands of neurons. Scaling this technology, however, suffers from brain-tissue response to electrode insertion resulting in progressive degradation of neuronal signal. Current approaches to solve this problem are to minimize wound severity by developing large multielectrode arrays with electrodes stiff enough for brain insertion that are either thin or become flexible once implanted into the tissue. An additional problem is that massive signal processing of spikes recorded by electrodes is challenging because spike classification methods typically rely on manual or semi-automatic processing. Alternative approaches that place electrodes on the surface involve less tissue displacement, and are more biocompatible. However, while single neuron activity can be sparsely sampled from the cortical surface, the range and specificity of surface recording and stimulation is currently limited. Therefore, scaling of multielectrode array recording to sample large neural populations is problematic. In addition, the spatial relationships between neurons in a population are more difficult to discern.

A promising approach is optical recording/modulation of neuronal activity made possible by development of genetically engineered calcium indicators (GECIs), such as the sensitive red sensor jRCaMP1a, and optogenetic modulators. See, e.g., Chen, T. W. et al., Ultrasensitive fluorescent proteins for imaging neuronal activity, Nature 499, 295-300, doi:10.1038/nature12354 (2013); Dana, H. et al., Sensitive red protein calcium indicators for imaging neural activity, Elife 5, doi:10.7554/eLife.12727 (2016); Emiliani, V. et al., All-Optical Interrogation of Neural Circuits, J Neurosci 35, 13917-13926, doi:10.1523/JNEUROSCI.2916-15.2015 (2015); and Grosenick, L. et al., Closed-loop and activity-guided optogenetic control, Neuron 86, 106-139, doi:10.1016/j.neuron.2015.03.034 (2015), each of which is hereby incorporated herein by reference in its entirety for all purposes and particularly for teaching of the use of GECIs such as JRCaMP1a, and of other optogenetic modulators. In this case, there are no electrodes penetrating the tissue because light is used to record neural activity. A major challenge in optical imaging is the ability to record from deep light-scattering brain tissue. In head-fixed animals, this has been mitigated by using two and three photon imaging, which involves laser sources that have higher powers and short pulse durations. However, this high power requirement complicates implementation, for example, such that wireless implementation is not practical. Moreover, the head-fixed setup typically required in such systems undesirably constrains the behavior of the animal or subject, and a tethered implementation has small field of view. Head-mounted and fiber-coupled microscopes typically have a limited imaging depth, and as they are typically designed for widefield illumination, they suffer from a lack of spatial precision for stimulation.

Thus, current imaging technologies have multiple limitations that curtail effectiveness. Most imaging systems either constrain natural movement and behavior (through head-fixation), do not allow for simultaneous high-resolution functional imaging with spatially-localized neuromodulation, and/or are restrained to single, small field of view (FOV).

Accordingly, improved systems and methods for rapid volumetric neural sensing and modulation are needed, particularly to access larger cortical regions.

### SUMMARY OF THE DISCLOSURE

One aspect of the disclosure provides a method for modulation and imaging of tissue, the method comprising:
conducting patterned optical radiation of an optogenetic wavelength in an input direction along a beam path through a lens system comprising one or more lenses, thereby focusing the optical radiation at a focal surface (e.g., focal plane) in the tissue to modulate the tissue;
conducting patterned optical radiation of a imaging wavelength through the lens system along the beam path in the input direction, thereby focusing the optical radiation at the focal surface (e.g., focal plane) in the tissue, the patterned optical radiation causing an optical signal to be emitted from the tissue from the focal surface, the optical signal being in the form of patterned optical radiation;
conducting the optical signal from the tissue along the beam path in an output direction through the lens system to be focused on an image detector; and
detecting the optical signal using the image detector.

Another aspect of the disclosure provides a system for modulation and imaging of tissue, the system comprising:
a lens system comprising one or more lenses configured to focus optical radiation conducted therethrough in an input direction along a beam path at a focal surface (e.g., focal plane) in the tissue, the lens system being configured to provide axial scanning such that the focal surface can be scanned axially with respect to the beam path to provide a plurality of focal surfaces at different focal lengths from the lens system;
a source of patterned optical radiation of an optogenetic wavelength, the optical radiation of the optogenetic wavelength being configured to modulate a property of the tissue, the source of patterned optical radiation of the optogenetic wavelength being addressable to provide a plurality of different patterns of patterned optical radiation, the system being configured to conduct optical radiation from the source of patterned optical radiation of the optogenetic wavelength through the one or more lenses in the input direction along the beam path to be focused at the focal surface;
a source of patterned optical radiation of a imaging wavelength, the source of patterned optical radiation of the imaging wavelength being addressable to provide a plurality of different patterns of patterned optical radiation, the system being configured to conduct optical radiation from the source of patterned optical radiation of the imaging wavelength through the one or more lenses along the beam path to be focused at the focal surface, the optical radiation of the imaging wavelength being configured to cause an optical signal to be emitted from the tissue from the focal surface, the optical signal being in the form of patterned optical radiation;
an image detector configured to receive the optical signal emitted from the tissue, the system being configured to conduct the optical signal emitted from the tissue at the focal surface through the lens system in an output direction along the beam path to be focused on the image detector.

Other aspects are apparent from the detailed description provided below.

### BRIEF DESCRIPTION OF THE DRAWINGS

FIG. 1 is a schematic view of an optical system according to one aspect of the disclosure.

FIG. 2 is a schematic view of an optical interface for volumetric neural sensing and modulation. Overall design of an intracranial 3D-FAST electrowetting array showing one of the electrowetting lens microscope elements. Individual microscope elements can be stacked together in an array to obtain more coverage of the cortex without sacrificing the imaging rate.

FIG. 3A provides a ZEMAX model showing elements of individual miniature electrowetting microscope. The total length is 9 mm. A crossed-dichroic prism is used to combine the two wavelengths of light from the LEDs and transmit the emission light to the CMOS imaging detector. An electrowetting lens is used to adjust the axial focal plane in the image. The model is diffraction limited and chromatically corrected over the full field of view of 0.64 mm².

FIG. 3B provides a diagram of LED format for micro-patterned arrays. The 530 nm source array forms structured illumination at the sample at three different phases (0°, 90°, 180°). The detector can collect the three images and an algorithm removes the background leaving only the in-focus signal. The 488 nm source array can consist of hundreds of individually addressable pixels that can illuminate a region of 8 μm.

FIG. 4A provides confocal microscopy imaging, and FIG. 4B provides SIM imaging of fixed CCK-tdTomato mouse cortex, demonstrating that SIM attains background rejection comparable to confocal microscopy. Images were taken over the same region and are displayed as a function of depth in xy-, and in xz-projections. With SIM individual neurons were resolved up to a depth of ˜190 μm.

FIG. 5 provides a graph of total power of excitation light as a function of imaging depth in order to observe the same fluorescence signal at the detector (green line). The initial power is 300 μW. Power becomes 40 mW at a depth of ˜250 microns. Total power delivered from a single pixel on the 488 nm LED in order to achieve activation of ChR2 at different depths (blue line).

FIG. 6 provides a diagram showing the theory and operation of electrowetting lenses.

FIG. 7 provides a schematic cross-sectional view of an electrowetting liquid lens device, in which the Teflon AF layer is closest to the liquid, the parylene layer is intermediate, and the transparent electrode is farthest from the liquid. Side view schematic of the liquid lens tuning from its initial curved state (Left) to flat (Right) with the application of 14.5 V.

FIG. 8 provides a schematic view of a 4×5 electrowetting lens array, each lens having an aperture of 2 mm. The center to center separation between the lenses is 3 mm. An exploded view of the lens array with its components is at the bottom of the figure.

FIG. 9 provides a schematic view of a fabrication process flow for the LEDs. A foundry sourced LED is acquired and patterned to individually separate the top layer (the anode in this case), and isolate the cathode in strips. Matrix addressing can then use the isolated character of these conductive areas to create an addressed matrix. A patterned insulator and top metal layer is used to provide further interconnection and reduce the series resistance loss in the structure.

FIG. 10 provides a schematic depiction of a pattern of isolation and connection for pixel and bar illuminators. In both cases, 10 logical rows and 10 logical columns are provided, allowing for 100 individual elements to be addressed using 20 external connections.

FIG. 11 provides views of an example 10×10 passive matrix LED array, fabricated in InGaAs. Each pixel is individually addressable taking advantage of the rectifying behavior of the LEDs in the array.

FIG. 12 provides representative LED spectra from as-fabricated patterned wafers. The wafer corresponding to the top graph has a peak at 460 nm and FWHM of 20 nm, and the wafer corresponding to the bottom graph has a peak of 520 nm and FWHM of 36 nm.

### DETAILED DESCRIPTION

To address challenges in the art such as those described above in the Technical Background section, the present disclosure provides a variety of methods and systems for rapid modulation and sensing of tissue, e.g., neural tissue such as brain tissue.

For example, various embodiments of the present disclosure provide for a miniature microscope system and methods for using it for stimulating and imaging neural activity using light. The closest technology would be the miniscope, (e.g., a miniature wide field fluorescent microscope that incorporates an LED light source with optics, dichroics, and a miniature CMOS detector). Some of the differences of the present technology include the following:

1. Some embodiments include a miniature electrowetting electrically tunable lens that scans the focal length of the microscope to allow three-dimensional imaging. Electrowetting electrically tunable lenses are described in more detail, e.g, in U.S. Patent Application Publication no. 2017/0010456; and B. N. Ozbay et al., Three dimensional two-photon brain imaging in freely moving mice using a miniature fiber coupled microscope with active axial-scanning, Scientific Reports, 8:8108 (2018), each of which is hereby incorporated herein by reference in its entirety.

2. Some embodiments use microstructured LEDs for illumination with imaging radiation. As described herein, use of microstructured LEDs can provide for a patterned optical signal resulting from interaction at the focal plane (e.g., due to fluorescence or due to absorbance), which can be useful in image processing as described below.

3. Some embodiments employ a technique called Structured Illumination Microscopy (SIM) in which the optical scattering in tissue can be reduced in post-processing, thus allowing for the provision of a clearer image related to signal arising from the focal plane of the microscope.

4. Some embodiments use another set of microstructured LEDs for optogenetic stimulation. The LEDs can be, e.g., in a 10×10 grid, and can illuminate regions of interest to be modulated in the field of view of the microscope.

5. In some embodiments, the design can be modular, with several individual microscopes being stacked together for modulation/imaging over larger brain areas or in larger animals.

For example, various embodiments of the disclosure provide systems and methods that can allow for rapid, real-time precise optical modulation and volumetric neural recording. Such methods and systems can achieve unparalleled access to, and modulation of, neural circuitry in the cortex by pairing axial focusing capabilities, e.g., using electrowetting technology, with structured illumination, e.g., using a miniature array of LED emitters, together with a high-resolution, high-speed detector. In various embodiments, use of a modular design allows the systems and methods to be scalable and customizable to meet experimental needs. For example, certain embodiments of the disclosure can be configured to achieve duplex recording of ˜768,000 neurons and stimulation of ˜60,000 neurons, with spatial resolution of 2.9 μm and 8 μm for recording and stimulation, respectively. Various embodiments described herein can provide a field of view of ˜0.64 mm² in lateral area and ˜250 μm in axial depth; when configured as dual implants, this can provide a total sampling volume of ˜6.4 mm³ with >10 Hz sampling rate. Axial focusing, e.g., using electrowetting lenses, micro-patterned LEDs and the use of Structured Illumination Microscopy techniques to reduce background noise can provide spatiotemporal precision for recording and modulation with low power, no mechanical parts, and fast image rates. These advances can allow single-neuron imaging combined with closed-loop modulation of cortical circuits, and create the potential for the provision of wireless, untethered imaging capabilities.

In the following description, for the purposes of explanation, numerous specific details are set forth in order to provide a thorough understanding of embodiments of the present technology. It can be apparent, however, to one skilled in the art that embodiments of the present technology may be practiced without some of these specific details.

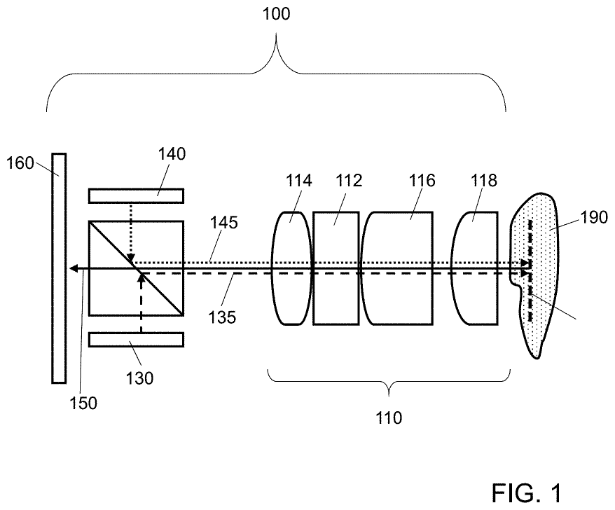

One embodiment of the disclosure is shown in schematic view in FIG. 1. A system 100 for the modulation and imaging of tissue 190 includes a lens system 110 comprising one or more lenses, here, an axially-tunable lens 112 and other lenses 114, 116, 118. The lens system is configured to focus optical radiation conducted therethrough in an input direction (left-to-right in FIG. 1) along a beam path (indicated by the arrows, see below) at a focal surface (here, focal plane 120). The lens system is to provide axial scanning (here, via axially-tunable lens 112, which has an axially-tunable focal distance), such that the focal surface can be scanned axially with respect to the beam path to provide a plurality of focal surfaces at different focal lengths from the lens system. Put a different way, the axial scanning can move the focal surface axially along the beam path.

System 100 also includes a source 130 of patterned optical radiation of an optogenetic wavelength. As used herein, radiation of an optogenetic wavelength is radiation that can modulate a property of the tissue, as described in more detail below. This can be, for example, a wavelength that can excite an optogenetic protein or opsins (light-activated ion channels). The source of patterned optical radiation of the optogenetic wavelength is addressable to provide a plurality of different patterns of patterned optical radiation. This, together with the axial tunability of the lens system, allows for selection of the region of tissue to be modulated. In the embodiment of FIG. 1 and in many other desirable embodiments, the source of patterned optical radiation of the optogenetic wavelength is a 2-dimensional LED microarray, e.g., with a pixel size in the range of 2-50 microns. The system is configured to conduct optical radiation from the source of patterned optical radiation of the optogenetic wavelength through the one or more lenses of the lens system in the input direction along the beam path to be focused at the focal surface. This is indicated schematically in FIG. 1 by arrow 135.

System 100 also includes a source 140 of patterned optical radiation of an imaging wavelength. The source of patterned optical radiation of the imaging wavelength is addressable to provide a plurality of different patterns of patterned optical radiation. This can allow for a selection of the region of tissue to be illuminated for imaging, and as described in more detail below, can be used to provide for computational methods for reducing the effect of noise in the imaging. In the embodiment of FIG. 1 and in many other desirable embodiments, the source of patterned optical radiation of the imaging wavelength is a LED microarray, e.g., with a pixel size in the range of 2-50 microns. The system is configured to conduct optical radiation from the source of patterned optical radiation of the imaging wavelength through the one or more lenses of the lens system in the input direction along the beam path to be focused at the focal surface. This is indicated schematically in FIG. 1 by arrow 145. The radiation of the imaging wavelength is configured to cause an optical signal to be emitted from the tissue from the focal surface, the optical signal being in the form of patterned optical radiation. This optical signal is indicated in FIG. 1 by arrow 150.

The system 100 also includes an image detector 160 configured to receive the optical signal emitted from the tissue. The system is configured to conduct the optical signal emitted from the tissue at the focal surface through the lens system in an output direction (right-to-left in FIG. 1) along the beam path to be focused on the image detector. This is indicated by arrow 150 in FIG. 1.

Accordingly, the system 100 is configured to conduct optical radiation 135 from the source 130 and optical radiation 145 from the source 140 to focus on the focal surface 120 in tissue 190, and to conduct the resulting optical signal 150 from the focal plane to the image detector 160. While the arrows 135, 145 and 150 are separated for clarity in FIG. 1, the person of ordinary skill in the art will appreciate that they desirably substantially overlap, such that the radiation of the optogenetic wavelength and the radiation of the imaging wavelength can probe the same region of material, to provide the optical signal to be imaged. Notably, in the system of FIG. 1 the source of patterned optical radiation of the imaging wavelength and the source of patterned optical radiation of the optogenetic wavelength are addressable, and the lens system is axially-tunable. Accordingly, the system can be used, without moving the system with respect to the tissue, to change one or more of (a) the region(s) of the tissue being modulated by the radiation of the optogenetic wavelength (i.e., by changing the pattern of the patterned optical radiation of the optogenetic wavelength); (b) the region(s) of the tissue being illuminated by the radiation of the imaging wavelength (i.e., by changing the pattern of the patterned optical radiation of the imaging wavelength); and/or (c) the axial position of the focal surface (i.e., by changing the focal length of the lens system), then repeat the conducting and detecting steps. This can allow for different optical signals relating to different illuminated regions to be collected by the image detector, which can provide different information for analysis. For example, changing the axial position of the focal surface can allow for three dimensional imaging, through the collection of a plurality of two-dimensional images at different depths. And as described in more detail below, changing the pattern of illumination can allow for the use of Structured Illumination Microscopy techniques to reduce the impact of background noise. Similarly, the system can be used to collect different images resulting from different locations of tissue modulation, here, too, without moving the system. And changing the pattern of radiation of the optogenetic wavelength allows modulation of different regions of tissue.

Also provided is a method for modulating and imaging a tissue; such a method can be described with reference to FIG. 1. The method includes conducting patterned optical radiation (135 in FIG. 1) of an optogenetic wavelength in an input direction (e.g., left-to-right in FIG. 1) along a beam path through a lens system (110 in FIG. 1) comprising one or more lenses (112, 114, 116 and 118 in FIG. 1), thereby focusing the optical radiation at a focal surface (e.g., focal plane 120 in FIG. 1) in the tissue 190, to modulate the tissue. The method also includes (e.g., simultaneously) conducting patterned optical radiation (145 in FIG. 1) of a imaging wavelength through the lens system along the beam path in the input direction, thereby focusing the optical radiation at the focal surface (e.g., focal plane) in the tissue, the patterned optical radiation causing an optical signal (150 in FIG. 1) to be emitted from the tissue from the focal surface, the optical signal being in the form of patterned optical radiation. The optical signal is conducted from the tissue along the beam path in an output direction (e.g., right-to-left in FIG. 1) through the lens system to be focused on an image detector 160. The optical signal is detected using the image detector 160.

As used herein, radiation of the imaging wavelength is radiation configured to cause an optical signal to be emitted from the tissue from the focal surface in the form of patterned optical radiation. This can provide for a number of different types of imaging. For example, in certain embodiments, the imaging wavelength is configured to selectively cause a fluorescence emission from the tissue. In this case, the wavelength of the optical signal is the fluorescence wavelength resulting from absorption of the radiation of the imaging wavelength by the tissue. A number of species can be used for this, e.g., a genetically-encoded calcium indicator such as the red calcium ion sensor jRCaMP1a having a fluorescence absorption at ˜530 nm. To avoid the need for higher power sources, the fluorescence excitation is desirably a single-photon process. In other embodiments, the imaging wavelength simply causes selective absorption in the tissue, in which case the optical signal is formed by radiation of the imaging wavelength not absorbed.

In certain desirable embodiments, the method further includes changing one or more of (a) the pattern of the patterned optical radiation of the optogenetic wavelength, (b) the pattern of the patterned optical radiation of the imaging wavelength, and/or (c) the focal length from the lens system of the focal surface, then repeating each conducting step and the detecting step. As described above, changing the axial position of the focal surface (by changing the lens system focal length) can allow for three dimensional imaging, through the collection of a plurality of two-dimensional images at different depths. And as described in more detail below, changing the pattern of optical radiation of the imaging wavelength can allow for the use of Structured Illumination Microscopy techniques to reduce the impact of background noise. Similarly, by changing the pattern of radiation of the optogenetic wavelength the system can be used to collect different images resulting from different locations of tissue modulation, here, too, without moving the system.

For example, the methods as otherwise described herein can include obtaining a plurality of images at a plurality of lens system focal lengths. This can desirably allow for the provision of 3D imaging data.

As described above, the lens system includes one or more lenses configured to focus optical radiation conducted therethrough in an input direction along a beam path at a focal surface. This can be, e.g., a focal plane, as shown in FIG. 1. However, in other desirable embodiments, the focal surface is not planar. Notably, the lens system is configured to provide axial scanning such that the focal surface can be scanned axially with respect to the beam path to provide a plurality of focal surfaces at different focal lengths from the lens system. Desirably, this axial scanning is provided without requiring physical motion of the packaged system itself. In certain desirable embodiments, as described in more detail below, axial scanning is provided by including an axially-tunable lens as a component of the lens system. The axially-tunable lens can be, for example, an electrowetting lens. Electrowetting lenses are described in more detail below. See, e.g., Watson, A. M. et al. Focus-tunable low-power electrowetting lenses with thin parylene films, Applied Optics 54, 6224-6229 (2015), which is hereby incorporated herein by reference in its entirety for all purposes and particularly for its disclosure regarding electrowetting lenses suitable to be adapted for use in the systems described herein. In certain embodiments, the electrowetting lens is only axially-tunable, e.g., cylindrically-shaped with a first electrode along an endface of the cylinder and with a second electrode along the cylindrical surface of the cylinder, configured such that a potential placed across the electrodes provides tuning by changing the shape of a meniscus between two fluids of different refractive index. However, in other embodiments, the electrowetting lens is axially- and laterally-tunable. Such electrowetting lenses can be similar to the axially-tunable lenses described above, but with multiple separately-addressable electrodes along the cylindrical surface. Such electrowetting lenses are described in International Patent Application Publication no. WO2019/070892, which is hereby incorporated by reference in its entirety for all purposes and particularly for its description of using adaptive optics with multielectrode electrowetting lenses to correct for tissue aberrations, maintaining better spatial localization. Multielectrode electrowetting lenses are further described in International Patent Application Publication no. WO2015/112770, which is hereby incorporated by reference in its entirety for all purposes and particularly for its description of using multielectrode electrowetting lenses to shift the lateral position of focus; in certain embodiments as described herein, such techniques can be used to shift the position of the imaged area, e.g., to ensure a location of interest is fully imaged.

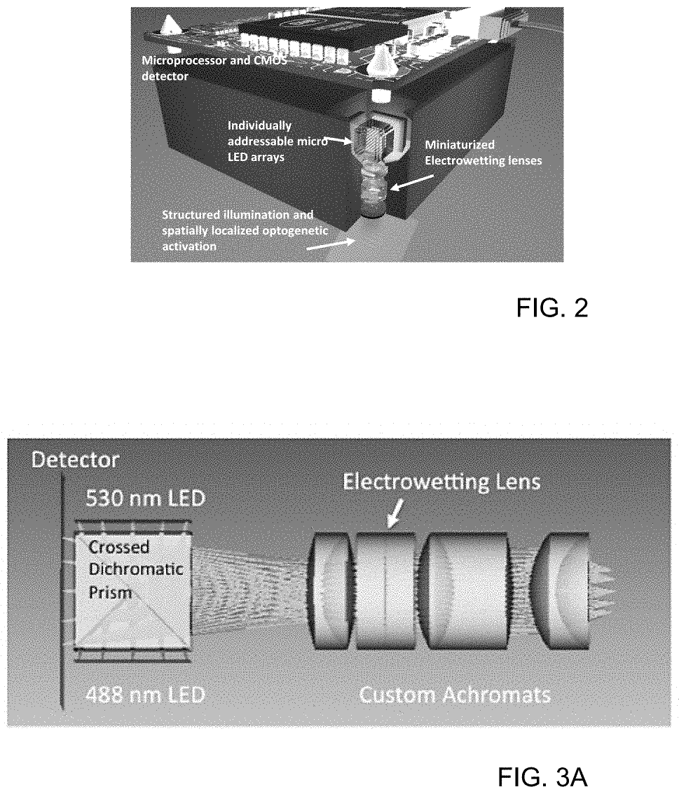

Other lenses of the lens system can be adapted to provide the desired focal characteristics of the system, for example, as shown in FIG. 1 above and in FIG. 2 below. For example, in the embodiment of FIG. 1, each of the lenses 114, 116, 118 can be achromatic lenses that provide the desired overall focal characteristics demonstrated. The person of ordinary skill in the art can use optical simulation software such as ZEMAX or LIGHTTOOLS to determine the properties of such lenses; conventional techniques can be used to fabricate them.

A variety of sources of patterned optical radiation of the optogenetic wavelength can be used in the systems and methods described herein. Notably, the source of patterned optical radiation of the optogenetic wavelength is addressable to provide a plurality of different patterns of patterned optical radiation. These patterns need not be complex; in many cases one pattern is a single spot at one location, and another pattern is a single spot at a different location, to provide for switching between different modulated regions of the tissue. A variety of sources for generating patterned radiation can be used, e.g., using digital micromirror arrays, optical fiber bundles, and/or holographic sources based on liquid crystal modulators, which can be employed with laser sources as well as light emitting diodes (LED). Additionally, the use of prisms or mirrors to create interference patterns from a single laser or LED source can be used to provide the structured illumination. But in certain especially desirable embodiments, the source of patterned optical radiation of the optogenetic wavelength is a light emitting diode (LED) array, e.g., a microarray. As described in detail below, LED arrays can provide a number of advantages, especially with respect to addressability and size suitable for provision in a compact device.

The optogenetic wavelength will vary depending on the type of modulation of the tissue desired. As described above, radiation of an optogenetic wavelength is radiation that can modulate a property of the tissue. This can be through a variety of methods, e.g., by modulation of function of a protein or by modulation (e.g., reversible) of a physical property of the tissue. The modulation can be, for example, a stimulation of a response or effect in the tissue, e.g., a neural response. But other types of modulation are possible (e.g., an inhibition of a response). In certain embodiments as described herein, various light-sensitive ion channels or opsins are used to provide the optogenetic modulation. The target tissue is often neurons, that have been genetically modified to express these light-sensitive ion channels. In certain embodiments, the optogenetic wavelength is in the range of 460-510 nm, e.g., 480-500 nm. One common optogenetic wavelength is about 488 nm. Of course, other phenomena can be used to provide the modulation, e.g., photoactivation of caged compounds or infrared neuromodulation through thermal effects. The optogenetic wavelength desirably differs from the imaging wavelength by at least 10 nm, e.g., at least 20 nm. Similarly, the optogenetic wavelength desirably differs from the peak wavelength of the optical signal by at least 10 nm, e.g., at least 20 nm.

A variety of sources of patterned optical radiation of the imaging wavelength can be used in the systems and methods described herein. Notably, the source of patterned optical radiation of the imaging wavelength is addressable to provide a plurality of different patterns of patterned optical radiation. These patterns need not be complex; in many cases one pattern is a first series of bars, another pattern is a second series of bars shifted from the first, and another pattern is a second series of bars shifted from the second and the first. This can provide three independent optical signals that can be recorded and through processing converted to an image with a reduced amount of noise. A variety of sources can be used, e.g., using digital micromirror arrays, optical fiber bundles, and/or holographic sources based on liquid crystal modulators to couple light from a laser (e.g. LED) into the system. But in certain especially desirable embodiments, the source of patterned optical radiation of the imaging wavelength is a light emitting diode (LED) array, e.g., a microarray. As described in detail below, LED arrays can provide a number of advantages, especially with respect to addressability and size suitable for provision in a compact device.

The imaging wavelength will vary depending on particular optical signal desired from the tissue (e.g., through fluorescence or absorption microscopy). In certain embodiments, the imaging wavelength is in the range of 500-570 nm, e.g., 520-540 nm. One common imaging wavelength is about 530 nm. In certain embodiments (e.g., when the optical signal results from fluorescence or some other phenomenon other than mere absorption), the imaging wavelength desirably differs from the peak wavelength of the optical signal by at least 10 nm, e.g., at least 20 nm.

As described above, the system also includes an image detector configured to receive the optical signal emitted from the tissue. A variety of image detectors can be used. The image detector desirably has at least 20×20 pixels, more desirably 50×50 pixels or even 100×100 pixels. While a variety of image sensor types can be used, as described below, use of a CMOS image detector can provide a number of advantages.

The image detector, the sources and the lens system can be arranged together in a number of ways to provide the operation described herein. It can be desirable to combine the output radiation of the sources so that they are roughly copropagating through the system. In certain embodiments a beam splitter can be used to combine the image detector, the sources and the lens system into a compact optical system. For example, certain embodiments, the system further includes a beam splitter that is configured to (a) receive optical radiation from the source of patterned optical radiation of the optogenetic wavelength and transmit it along the beam path through the one or more lenses of the lens system; (b) receive optical radiation from the source of patterned optical radiation of the imaging wavelength and transmit it along the beam path through the one or more lenses of the lens system; and (c) receive optical radiation along the beam path from the lens system and transmit it to the image detector. Beam splitter 170 in the system of FIG. 1 performs this function. While the sources are arranged opposite one another in FIG. 1, the person of ordinary skill in the art will appreciate that other configurations are possible. The beam splitter can be dichroic, e.g., having a reflectivity that is wavelength-dependent to selectively route radiation of the different wavelengths (e.g., optogenetic wavelength, imaging wavelength, wavelength of optical signal) in appropriate directions. Additionally or alternatively, one or more optical filters can be used, e.g., to filter out radiation of the optogenetic wavelength and/or the imaging wavelength to substantially prevent them from reaching the imaging detector.

The image detector can provide a series of image data for processing. The system can therefor include a processor configured to perform image processing to provide processed images. This can include, for example, assembling multiple images taken at different depths into a 3D image, performing the image processing necessary for Structured Illumination Microscopy as described below, and/or coalescing multiple images (e.g., 3D images) into video. A processor (the same processor as described above or a different one) can in some embodiments be configured to control the illumination by the optical sources. For example, such a processor can control the addressing of the source of patterned radiation of the optogenetic wavelength and/or the source of patterned radiation of the imaging wavelength to provide different patterns at different times. The processor can accept input, e.g., from a user selection, to determine the patterns to be provided. A processor can be operatively coupled to the image sensor and/or sources as appropriate, e.g., through one or more wires or cables. A variety of processors can be suitable for use, e.g., a general purpose computer, a phone or tablet, or a purpose-built microprocessor.

Structured illumination microscopy is a known technique for removing background noise in microscopy. The technique involves, at a single optogenetic illumination pattern and focal position, acquiring three or more images at three or more different patterns of radiation of imaging wavelength. The processor can be used to perform image processing such as that used in structured illumination microscopy or similar techniques to provide a single processed image from the three or more acquired images, with the goal of reducing background noise as described in more detail below. In certain embodiments, the systems and methods are configured to use structured illumination microscopy processing to reduce noise.

The systems described herein can be provided in array form, in which a plurality of lens systems, each with its own associated pair of sources and detector, can be integrated into an array. This can allow for simultaneous imaging at a number of locations spread over a wider area of tissue. As described in more detail below, 3D printing techniques can be used to provide cylindrical bores in which the lens systems can be provided.

The systems described herein can be packaged in compact form, to allow for mounting on an animal. For example, in certain desirable embodiments, the systems described herein are packaged in an enclosure that is no larger than 5 cm×5 cm×5 cm.

The systems and methods described herein can be used with a variety of tissue types. While the present disclosure describes the use of brain tissue specifically, the person of ordinary skill in the art will appreciate that various other tissues can be modulated and imaged using the methods and systems described here.

Particular non-limiting implementations are described in text below. The person of ordinary skill in the art will appreciate that the embodiments otherwise described herein can be modified using features from the implementations described below.

To meet various challenges in existing technologies, the present inventors disclose an optical device (′3D-FAST) that allows for rapid, real-time volumetric neural recording and precise optical stimulation. To build a low-power (and optionally fully implantable and wireless) optical device, various implementations of the present disclosure provide for achieve deep-tissue imaging using one or more several innovative approaches: axial focusing (e.g., with electrowetting lenses); micropatterned LEDs for increased stimulation specificity and patterned light delivery; structured illumination to improve depth resolution; and a compact, modular design based on a 3D-printed scaffolding. This system allows closed-loop optical neuromodulation at a single-neuron level over a large area of neural tissue in a customizable form factor tailored to experimental needs.

Thus, the system of the implementations described below can provide access to, and modulation of, neural circuitry in the cortex by pairing axial focusing capabilities using electrowetting technology with a miniature array of LED emitters and a high-resolution, high-speed detector. Due to its modular design, the implementations described here can be scalable and customizable to meet experimental needs. This can, for example, achieve duplex recording of ˜768,000 neurons and stimulation of ˜60,000 neurons, with spatial resolution of 2.9 μm and 8 μm for recording and stimulation, respectively. These advances can allow single-neuron imaging combined with closed-loop modulation of cortical circuits, and create the potential for future designs to include wireless, untethered imaging capabilities.

The implementations described herein can provide rapid 3D-imaging and selective optogenetic stimulation of specific elements of neural circuits, allowing modulation of and recording from, e.g., thousands of neurons using one or more of the following innovations:

i) Axial focusing without moving parts can be achieved with an electrically tunable electrowetting (EW) lens, e.g., provided in array form. Each of element (e.g., of the multiple elements of an array) can have, for example, a cylindrical sampling volume of ˜0.64 mm² in area by ˜250 μm axial depth with ˜2.9-μm resolution. Resulting from the use of axial focusing capabilities, this sample volume is larger than other electrical or optical sensing modalities, and allows for precise, spatially limited optogenetic activation.

ii) Micropatterned illumination (e.g., using a micropatterned LED array) allowing for computational imaging and targeted stimulation. Each micropatterned LED array can have individually addressable 5-50 μm pixels that provide additional control of illumination structure and specificity.

iii) Implementation of computational imaging strategies to improve depth resolution. Use of patterned illumination (e.g., using a controllable micropatterned LED array) allows for the use of structured illumination microscopy (SIM) to acquire images with reduced signal to noise to increase imaging depth to ˜250 μm.

Accordingly, the implementation described here brings together concepts from the fields of optics and computational imaging in a package that is designed to be modular, scalable and customizable to experimental needs. This can be miniaturized to provide an implantable, wireless imaging solution for closed-loop optical measurement and modulation in the brain of a freely-behaving animal. Thus, the implementation described here can provide a number of advantages, including: 1) creation of a modular, scalable solution tailored to experimental needs; 2) provision of closed-loop neuromodulation solutions with high spatiotemporal precision; 3) provision of volumetric, real-time imaging with relatively low power requirements; and 4) provision of technologies enabling a fully-implantable, wireless imaging solution amenable to freely-moving, untethered and naturalistic behavioral experiments.

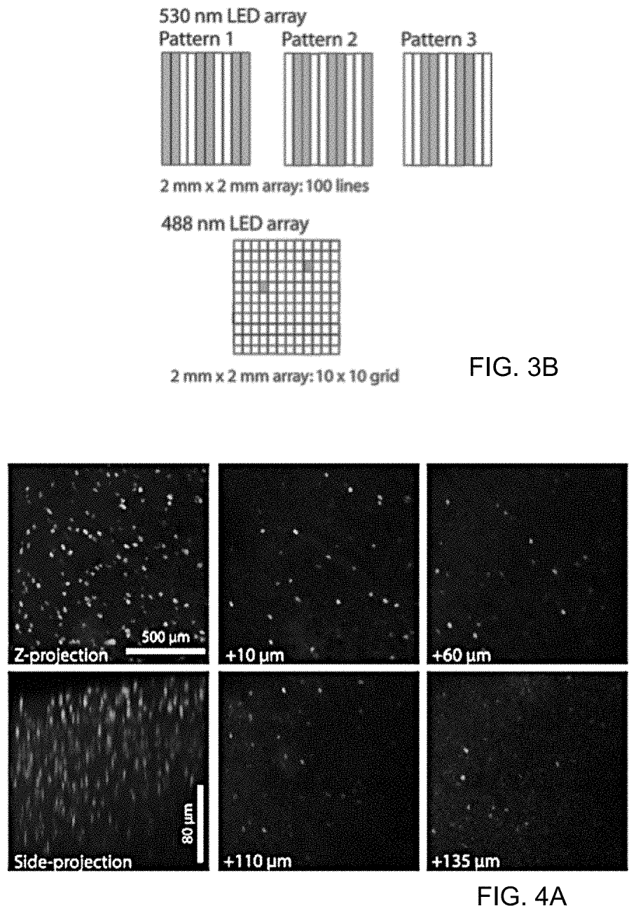

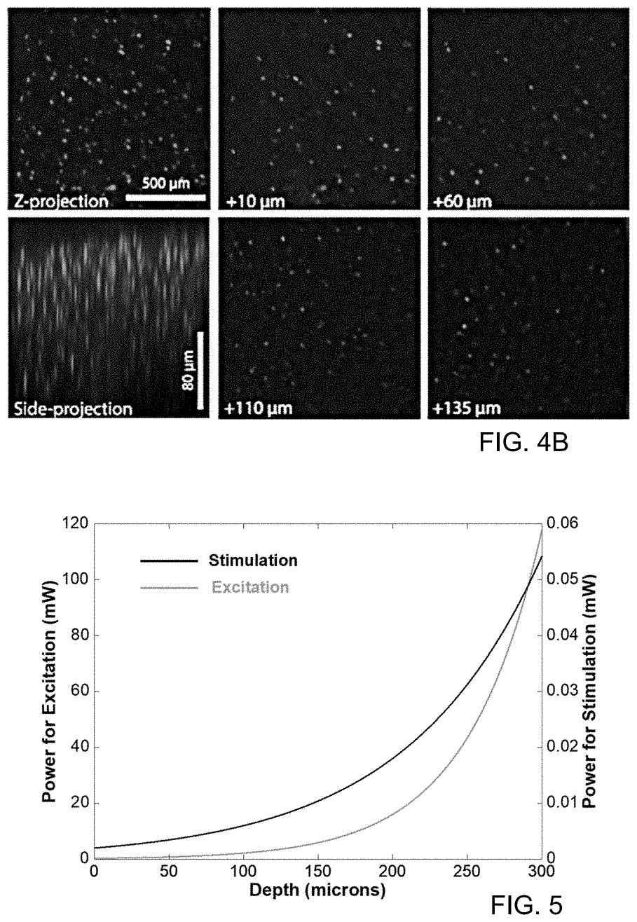

As described above, the device can be provided as an array of individual microscope elements. In one implementation, each miniature microscope element is equipped with LED arrays for fluorescence excitation of the red Ca²⁺ sensor jRCaMP1a at 530 nm and activation of neurons with optogenetic activator channel rhodopsin (ChR2-YFP) at 488 nm (see element schematics, FIGS. 2 and 3A). The use of this red sensor protein facilitates reaching 250 μm depth for neuronal cortex imaging. Each element uses a low-power, high-frame rate CMOS sensor to attain 3D volume imaging of changes in neuronal Ca²⁺ at >10 Hz, a rate suitable to record neuronal activity that contains cortex input information necessary for decoding the sensory input. This can be an individual image sensor for each lens system, or can be implemented with a plurality of lens systems associated with a single image sensor. Through use of micro-patterned LEDs, the system can use structured illumination (SIM) image processing to reject out-of-focus light and patterned illumination for precise spatio-temporal activation of neurons by light. Provided below is preliminary SIM imaging data to demonstrate that this wide field microscope design is promising for effective optical sectioning to depths of 250 μm in brain cortex (FIG. 4). Power use of the different components (LEDs, CMOS image sensor and signal processing hardware) can be provided to achieve safe, continuous use of the system.

Optical readout and stimulation with a lower power budget and small footprint on cortex makes desirable the use of light emitting diodes (LEDs) that provide continuous wave (CW) light for fluorescence excitation. In the implementation described here, the excitation light is focused through a dynamic focusing element (electrowetting lens) that is robust, non-mechanical, and impervious to any motion or vibration. The focal length of these lenses can be adjusted in a rapid manner by changing the applied voltage and only require μW of electrical power. Electrowetting lenses for fast, dynamic focusing in a miniature fiber-coupled microscope for full 3-D volume confocal fluorescence imaging in brain tissue slices and in vivo in awake-behaving mice has previously been shown. Multiphoton excitation with an axial scan range of ˜500 μm has also been achieved using an electrowetting lens design. See, e.g., Ozbay, B. N. et al. Miniaturized fiber-coupled confocal fluorescence microscope with an electrowetting variable focus lens using no moving parts, Optics letters 40, 2553-2556, doi:10.1364/ol.40.002553 (2015), which is hereby incorporated herein by reference in its entirety for all purposes and particularly for its teachings with respect to axially-scannable electrowetting lenses suitable for use in various embodiments of the disclosure.

Typical wide field fluorescence imaging in tissue is limited to depths of tens of microns due to light scattering. In order to acquire images at greater depths, it is desirable to find a method for removal of background out-of-focus light from the in-focus signal. In the implementations described herein structured illumination microscopy techniques can be used for removal of out-of-focus scattered light. See, e.g., J. Huisken et al., Optical Sectioning Deep Inside Live Embryos by Selective Plane Illumination Microscopy, Science, Aug. 13, 2004, 1007-09; Verveer et al., Theory of confocal fluorescence imaging in the programmable array microscope (PAM), Journal of Microscopy, 189:192-198 (1998); Bozinovic N eg al., Fluorescence endomicroscopy with structured illumination, Opt Express. 16(11):8016-8025 (2008); and V. Poher et al., Optical sectioning microscopes with no moving parts using a micro-stripe array light emitting diode, Opt. Express 15, 11196-11206 (2007); and Szabo V, et al., Spatially Selective Holographic Photoactivation and Functional Fluorescence Imaging in Freely Behaving Mice with a Fiberscope, Neuron. 2014; 84(6):1157-1169. doi:10.1016/j.neuron.2014.11.005, each of which is hereby incorporated herein by reference for all purposes and particularly for its description of computational techniques to address background out-of-focus light. The implementation described here can use a micropatterned LED array (or some other patterned illumination source) for structured illumination microscopy (SIM) to remove background fluorescence and enhance the imaging depth for 3D volume imaging. The micropatterned LED array (or other patterned illumination source) removes the need for additional optical and mechanical components to create the SIM patterns.

Microscope Design Parameters

A preliminary design of an individual 3D-FAST-ELM miniature electrowetting microscope element was determined using Zemax ray-tracing software. FIG. 3A shows the model of the optical design including the relative dimensions and Table 1 details the design parameters. The total size, including all optics and electrowetting lens, is 2 mm×2 mm×9 mm making it a very compact and lightweight. The microscope optics have a 2.5× magnification, giving a FOV of 0.64 mm². The electrowetting lens allows adjustment of the focal depth over a range of ˜250 μm. This defines a total volume of 0.16 mm³ for readout and stimulation of an individual microscope element. The total image area can be increased by stacking multiple microscopes together and imaging together on a single CMOS detector.

TABLE 1
Parameters for an individual Single Electrowetting Microscope

| | |
|---|---|
| Active Detector Area (mm²) | 4 |
| Detector pixel size (μm) | 3.6 |
| Numerical Aperture | 0.3 |
| Magnification | 2.5 |
| Image area (mm²) | 0.64 |
| Nyquist detection resolution (μm) | 2 |
| Structured Illumination Parameters | |
| LED line width (μm) | 15 |
| LED space in between lines (μm) | 5 |
| Illumination Spatial Frequency (mm⁻¹) | 31.25 |
| Stimulation | |
| LED pixel size (μm) | 20 |
| Illuminated spot size (μm) | 8 |

FIG. 3B shows the design of micro-patterned LEDs suitable for use in this implementation. A grating for SIM is made using a 530 nm LED array with individually addressable lines of 15 μm. By turning on different lines, one can generate illumination ratings at separate phases (e.g., 0°, 90°, 180°). Of course, with respect to a particular system and a particular tissue a different set of illumination patterns can be used; the person of ordinary skill in the art knowledgeable with conventional SIM techniques can determine these based on experimental factors including the coefficient of the brain and optics of the setup. To perform SIM, three separate images are acquired for the three illumination patterns, and image computation removes the out-of-focus light. See, e.g., Dan, D. et al., DMD-based LED-illumination super-resolution and optical sectioning microscopy, Scientific reports 3, 1116, doi:10.1038/srep01116 (2013); Krizek, P., Raska, I. & Hagen, G. M., Flexible structured illumination microscope with a programmable illumination array, Opt Express 20, 24585-24599, doi:10.1364/OE.20.024585 (2012), each of which is hereby incorporated herein by reference for all purposes and particularly for its description of structured illumination techniques suitable for use in various embodiments of the disclosure.

Stimulation of individual neurons can be achieved using a second micro-patterned LED array at 488 nm in a grid pattern consisting of hundreds of individually addressable pixels. The light from the two wavelength LEDs are combined using a crossed dichroic prism to allow for simultaneous imaging and excitation of individual neurons across the full 3D volume.

Background Subtraction Using Structured Illumination.

Background rejection in wide-field microscopy is challenging due to the fact that out-of-focus scattered light is also collected, reducing the signal to noise of the in focus image. SIM allows removal of this out-of-focus light increasing the imaging depth. The amount of out of focus light removed depends on the effective axial resolution of the reconstructed SIM image, Z_{SIM}. Both Z_{SIM} and the signal-to-noise of the reconstructed SIM image, SNR_{SIM}, depend on the spatial frequency and modulation depth of the SIM illumination grating pattern. Using the Stokseth approximation for the off-focus optical transfer function and defining the axial resolution as the point at which mean fluorescence intensity drops to ½ the value at the focal plane, it is calculated that Z_{SIM} for the proposed optical parameters, with a spatial frequency of 31.5 mm⁻¹, is ˜40 μm. See, e.g., Karadaglić, D. & Wlson, T., Image formation in structured illumination wide-field fluorescence microscopy, Micron 39, 808-818, doi:10.1016/j.micron.2008.01.017 (2008); and Stokseth, P. A., Properties of a Defocused Optical System, Journal of the Optical Society of America 59, 1314, doi:10.1364/JOSA.59.001314 (1969), each of which is hereby incorporated herein by reference in its entirety for all purposes and particularly for description of computations.

Although this axial resolution is larger than the size of a single neuron, as neurons typically fire at different rates, single-neuron response can be determined by monitoring over time.

The person of ordinary skill in the art can select SIM parameters for the structured illumination source and for the overall method by a variety of methods, including one or more of optical modeling and optical testing. For example, in one implementation, SIM parameters can be tested using a bench-top laser with a digital micro-mirror device (DMD) to test axial resolution using the same grating spacing as the structured LED array. When an LED array is used to create the SIM pattern, the precise pattern is known and only a loss of modulation depth due to incoherent scattering alters the pattern at individual focal planes. A set of algorithms to achieve a rapid maximum-likelihood SIM background rejection that accounts for changes in refractive index and incoherent scattering of the sinusoidal SIM pattern can be selected. See, e.g., Kr̆íz̆ek, P., Lukes̆ T., Ovesný, M., Fliegel, K. & Hagen, G. M., SIMToolbox: a MATLAB toolbox for structured illumination fluorescence microscopy, Bioinformatics (Oxford, England) 32, 318-320, doi:10.1093/bioinformatics/btv576 (2016), which is hereby incorporated herein by reference in its entirety for all purposes and particularly for its teachings with respect to calculations useful in SIM.

Preliminary Results.

The present inventors obtained preliminary results showing removal of out-of-focus background using SIM imaging and compare this with confocal imaging over the same sample region, shown in FIGS. 4A and 4B. Fixed CCK-tdTomato mouse cortex was imaged. The fluorescence excitation and emission spectrum of tdTomato overlaps with that of the calcium indicator (jRCaMP1a) which can provide information on the imaging depth expected using the implementation described here. Both confocal microscopy (FIG. 4A) and SIM (FIG. 4B) were performed, with a long working distance 0.5 NA, 10× objective on a Nikon N-SIM super-resolution microscope. The illumination pattern at the sample was ˜6 μm, yielding a spatial frequency of 167 mm⁻¹. Equivalent or better signal-to-noise was demonstrated with the reconstructed SIM images compared with confocal microscopy, validating the technique. Up to a depth of ˜190 μm was imaged, up to the power limit of excitation light available. It is anticipated that one can achieve images to ˜250 μm using higher laser powers (see power calculations below and FIG. 5).

Optogenetic Activation.

In the implementation described here, optogenetic stimulation of individual neurons can be performed using the 488 nm LED grid to stimulate ChR2. Stimulation can be performed simultaneously with imaging allowing for real-time visualization and feedback. The full volume can be scanned at a rate of >10 Hz with 20-30 axial sections. The length of time at a given image depth can be approximately 5-6 ms over which one can apply the optogenetic activation. Different pixels on the optogenetic LED grid can be activated at a certain time during a scan in order to target those individual cells of interest. Light intensity from a single pixel on the 488 nm LED grid can be imaged (i.e., through the lens system) to a localized spot at the sample. The size of the focal spot can be determined by the LED pixel size and the properties of the microscope. A majority of the light intensity can be confined within ˜8 μm laterally and 30 μm axially. This limited region can allow selective stimulation of individual neurons by activating only one pixel on the grid. Of course, in activating individual cells, as light propagates in scattering tissue, spatial-localization is expected to get worse. One can mitigate this using soma targeted opsins resulting in sparser labeling. Moreover, in order to address tissue aberrations, one can use a multielectrode electrowetting lens to provide for adaptive optics to correct aberrations. The person of ordinary skill in the art can adapt the techniques described in International Patent Application Publication no. WO2019/070892, which is hereby incorporated by reference in its entirety for all purposes and particularly for its description of using adaptive optics with multielectrode electrowetting lenses to correct for tissue aberrations, maintaining better spatial localization. Multielectrode electrowetting lenses are further described in International Patent Application Publication no. WO2015/112770, which is hereby incorporated by reference in its entirety for all purposes and particularly for its description of using multielectrode electrowetting lenses to shift the lateral position of focus; in certain embodiments as described herein, such techniques can be used to shift the position of the imaged area, e.g., to ensure a location of interest is fully imaged.

Power Requirements for Imaging/Stimulation from LED Arrays.

The power requirements for the LED sources must take into account the scattering length of light in cortex tissue. As one images deeper in tissue, the total power delivered by the LED must be increased to maintain the same power at the focus. The scattering length of grey matter in human brain has been measured at different wavelengths; although reported for human cortex, these data can approximate the scattering lengths in non-human primates and rodents. The reported scattering lengths are lₛ˜97.1 μm at 530 nm (for jRCaMP1a excitation) and lₛ˜104 μm at 580 nm (for fluorescence emission). FIG. 5 shows the power for excitation (bottom line) and stimulation (top line) required as a function of image depth. For the 530 nm LED (excitation) an appropriate value is a total power of 300 μW at the focus, a level typically used for widefield fluorescence microscopy. As one images to depths greater than the scattering length, there is a marked increase in the required LED power to provide a desired signal at focus. To reach depths of 250 μm it is desirable to have ˜40 mW total power delivered. For the 488 nm LED, the powers required must be high enough for activation of ChR2. The intensity threshold for activation is ˜25 mW/mm² for 6 ms pulses. In this implementation, a single pixel of an LED grid can illuminate an area of 8 μm×8 μm at the sample. To achieve a 25 mW/mm² intensity without any tissue scattering, each pixel should deliver ˜2 μW. Tissue scattering at 488 nm typically requires an increase in the amount of power delivered by the LED as a function of depth, shown in FIG. 5 (top line). The power for activation at a depth of 250 μm is estimated to be ˜0.04 mW. In cases where LED power is enough to implicate tissue heating and/or photodamage, excitation light can be pulsed in time with the image sensor. As absorption of hemoglobin in blood at these wavelengths can be an issue, and so it can be desirable to avoid imaging large blood vessels. Development of new genetically encoded fluorescent proteins and indicators that excite and emit at longer wavelengths would allow deeper imaging at lower powers.

Electrowetting Lens Arrays.

Overview:

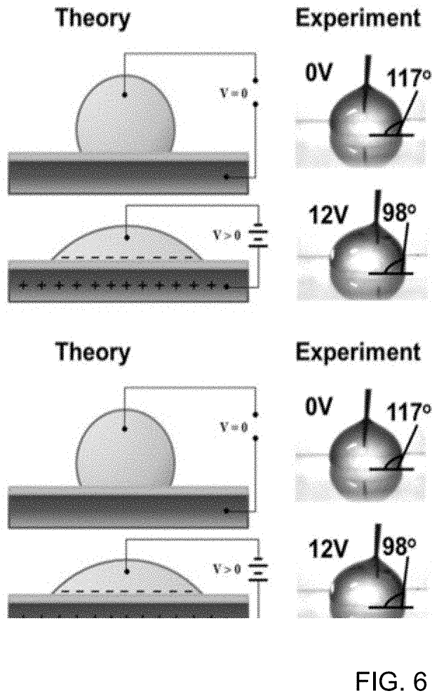

Depth scanning without mechanical parts is an important problem for designing compact optical imaging systems. Electrically tunable adaptive optical devices offer a very attractive solution. The present implementation focuses on electrowetting adaptive lenses, in which forces from an applied voltage shape a droplet of liquid. See FIG. 6. The same effect can be applied to two liquids of similar density placed in a cylindrical aperture, where electrowetting causes a change in the curvature at the liquid interface. Depth scanning in a microscope can be performed with motors or liquid crystal modulators, but electrowetting devices offer an excellent alternative with their potential for miniaturization, robustness, lack of moving parts, polarization insensitive operation, and fast response time. Electrowetting lenses are robust and impervious to motion or vibrations because they are governed only by surface tension forces and not gravity. In this implementation, individually-addressable electrowetting lens arrays are integrated into a complete optical device to implant for neural stimulation and readout. The large tuning range, compact size and minimal power draw of the electrowetting elements make them a favorable solution.

Principles and Advantages of Electrowetting Devices:

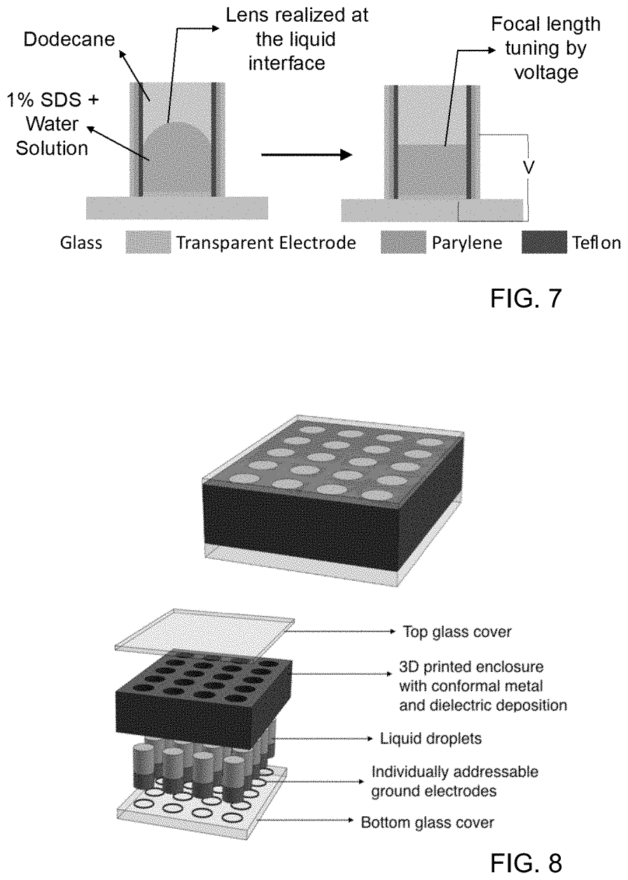

In this implementation, the electrowetting lenses include the liquid placed in a cylindrical aperture with contacts on both sides. Operation of an electrowetting lens is illustrated in FIG. 7. A cylindrical tube with functionalized sidewalls (electrode, dielectric and hydrophobic layers) is filled with a polar liquid and a non-polar liquid that are density matched. A substrate coated with a conductor functions as the second electrode. An applied voltage can be used to adjust the curvature of the liquid-liquid interface, enabling variable focus lenses.

The attractive features of electrowetting devices include: transmissive geometry; small size; low operating voltages; fast response time low insertion losses; polarization insensitivity; large stroke and good optical quality. These favorable properties make them a more versatile solution than technologies such as spatial light modulators, micro-electro-mechanical segmented (MEMS) and deformable mirror systems, piezo-actuated deformable mirrors, and flexible membrane liquid lenses. Electrowetting lenses have been demonstrated with record low-power dissipation (˜25 μW) large tuning ranges (˜40 diopters), and good optical quality (aberrations comparable to solid microlenses) while maintaining a compact footprint (1 mm micro-fabricated lenses). See, e.g., Watson, A. M. et al., Focus-tunable low-power electrowetting lenses with thin parylene films, Applied Optics 54, 6224-6229 (2015), which is hereby incorporated herein by reference in its entirety for all purposes and particularly for its disclosure regarding electrowetting lenses suitable to be adapted for use in the systems described herein.

Technical Approach. Design:

The lens arrays can be configured for robust operation, e.g., by using materials that avoid dielectric breakdown and provide long-term reliability. On top of one of the electrodes is a dielectric layer. This layer is desirably high quality (pinhole-free) and conformal to avoid charges from the liquid being injected into the dielectric. Finally, the last layer is a hydrophobic coating that must be able to be cycled with voltage, and be sufficiently hydrophobic to produce a large initial contact angle. The thicknesses of the materials are chosen to minimize applied voltage (thin layers produce better voltage sensitivity), but also to maximize dielectric breakdown (requires thicker materials).

2D Fabrication Process to Scale to Arrays:

One approach to make large arrays of individually addressable elements is based on 3D printing the cylindrical cavities for lenses. The cylindrical cavities can be conformally coated with metal and hydrophobic dielectric coatings. The metal coating on the sidewalls of the cylindrical cavities acts as the actuating electrode. The individually-addressable ground electrodes can be patterned on the bottom glass cover using standard lithography techniques and bonded to the 3D printed enclosure. Finally, a top glass cover can be bonded to the assembly after filling the cavities with liquids, to ensure encapsulation of the device. This design with 3D printed vertical sidewalls allows a high fill factor with individually addressable lens elements. FIG. 8 illustrates a schematic of the lens array and its assembly. The 4×5 array of 2 mm aperture lenses can be packaged in a 11 mm×14 mm×5 mm enclosure.

The electrodes (20 nm/200 nm, Chrome/Gold) are connected to contact pads, allowing for lens operation from outside the device enclosure. While a variety of materials can be adapted for use in the lens array, one useful material for the dielectric is Parylene HT and one useful material for the hydrophobic layer is Teflon AF 1600. This combination can achieve a large variation in contact angle (155° to 90°). Other suitable dielectric materials include, for example, atomic-layer deposited (ALD) Alumina (Al₂O₃) and Titanium Dioxide (TiO₂). ALD can provide a conformal and pinhole free dielectric film, enabling the reduction of charge injection and voltage requirements of the devices.

Led Fabrication. Overview:

Inorganic light emitting diodes (LEDs) represent a significant opportunity as the source of structured light for this implementation. Light emitting diodes offer the highest intensity and highest efficiency of any light source, and are available in a range of wavelengths. Thus, this implementation uses micro-LEDs in the optical path, and sequences the lighting synchronized with the tuning of the focusing elements to capture each layer separately and reduce the effect of scattered light and off-target captured elements on the acquired image.

Directly addressed, passive matrix addressed, and active matrix addressed micro-LED arrays for use in display and projection applications are known. See, e.g., Lee, V. W. & Kymissis, I., A directly addressed monolithic LED array as a projection source. Journal of the Society for Information Display 18, 808-812, doi:10.1889/JSID18.10.808 (2010); Lee, V. W. & Kymissis, I., 75.2 L: Late-News Paper: A Passive-Matrix Inorganic LED Array as a Projection Source, SID Symposium Digest of Technical Papers 43, 1013-1015, doi:10.1002/j.2168-0159.2012.tb05964.x (2012); Tull, B. R. et al., 26.2: Invited Paper: High Brightness, Emissive Microdisplay by Integration of III-V LEDs with Thin Film Silicon Transistors, SID Symposium Digest of Technical Papers 46, 375-377, doi:10.1002/sdtp.10256 (2015), each of which is hereby incorporated herein by reference in its entirety for all purposes and particularly for its teachings regarding LED arrays. In each case, the technology takes advantage of the availability of commercially sourced high-quality light emitting diodes grown using molecular beam epitaxy or metal organic chemical vapor deposition on single crystal substrates. These techniques allow for the formation of devices that have a high degree of purity, controllable bandgap, and controlled doping. These LEDs can be post-processed and structured into individual emitting elements. While LEDs are typically cut into single elements and packaged for indication and illumination applications, it is possible to structure the LED elements into a number of individual elements that can be addressed, in many cases taking advantage of the rectification offered by the diodes to deliver device isolation and element addressing. Depending on the array size, there are several options for system addressing. Both custom and stock LED epiwafers are broadly available from a number of suppliers in the United States, China, South Korea, and Taiwan.

Photonic Crystal Emission Cone Enhancement:

One of the issues relating to power efficiency is the near-Lambertian emission structure from the light emitting diodes. In a limited NA acceptance element, this leads to a situation in which all off-axis light is lost, leading to a significant decrease in system efficiency. One approach that can be used to improve this situation is the use of photonic crystals. It has been demonstrated that the on-axis emitted light from an LED can be increased six times by incorporating a photonic crystal with a vertical extraction mode on top of the LED, with a minimal impact on the LED thickness. The increase for the normal on-axis emission is approximately 6×, significantly improving the transfer efficiency into low NA acceptance systems, such as the envisioned scanning optical element. See Erchak, A. A. et al., Enhanced coupling to vertical radiation using a two-dimensional photonic crystal in a semiconductor light-emitting diode, Applied Physics Letters 78, 563-565, doi:10.1063/1.1342048 (2001), which is hereby incorporated herein by reference for all purposes and particularly for its teachings with respect to use photonic crystal for emission cone enhancement, which can be adapted for use in various embodiments described herein.

Packaging:

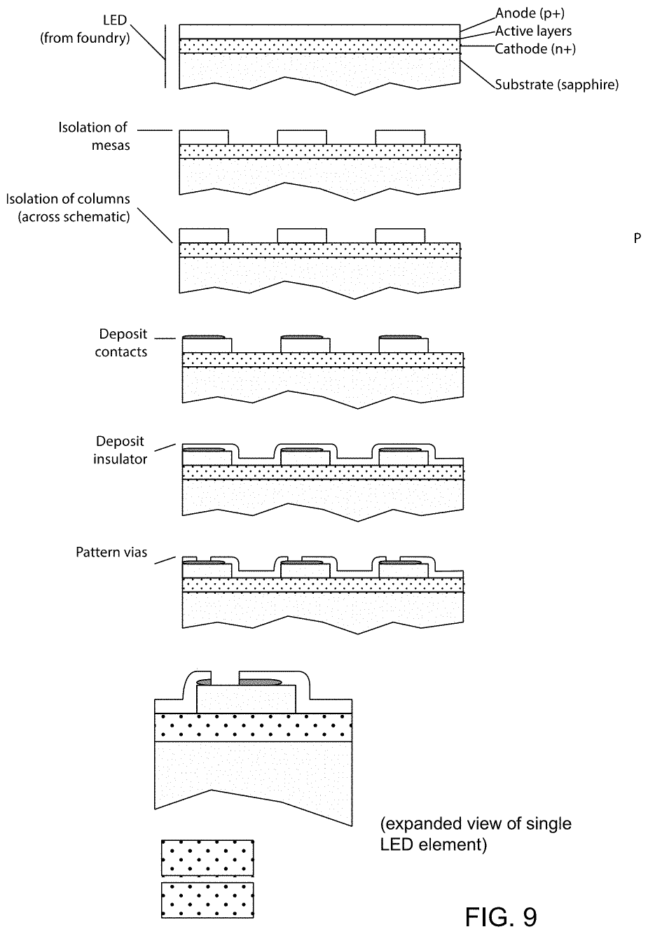

The light sources in the system of this implementation can be addressed using a passive matrix approach, with 100 elements in both structures. In both cases, matrix addressing is used to reduce the interconnect required to a manageable 20 pins per component. The rectification offered by the LEDs allows for passive matrix addressing of the components. Two LED structures can be fabricated to accommodate the needs of the optical system—one illuminator can consist of 100 bars, approximately 20 μm wide, and the other can consist of a 10×10 array of individual square elements. The structuring of the micro-LEDs can follow the process in FIG. 9, which patterns the doped layers and adds an insulating layer and layer of metal interconnect to the structure.

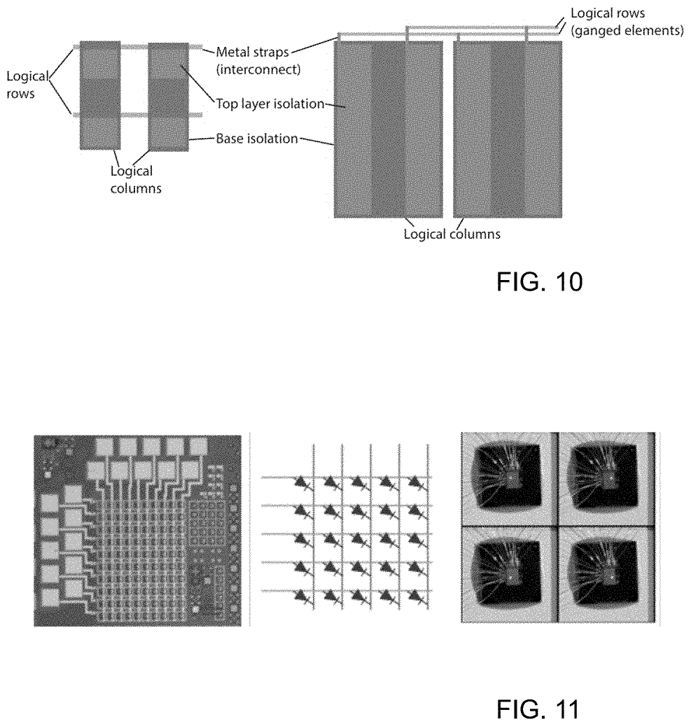

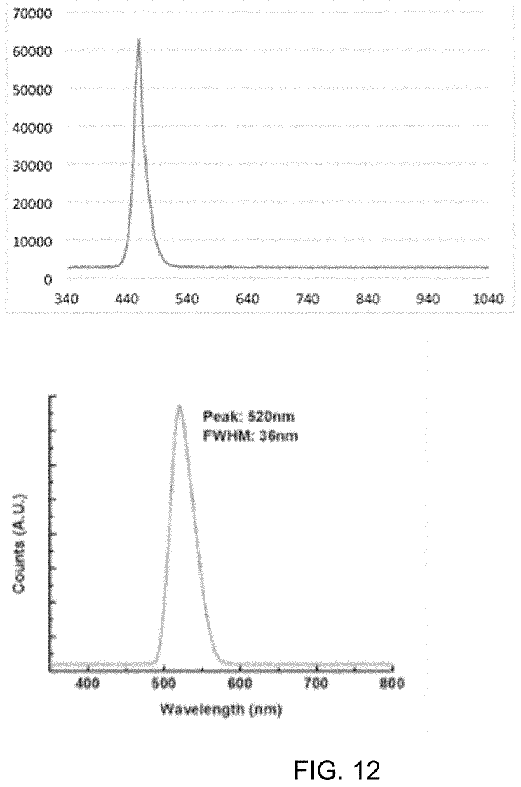

Both the pixel and bar-type structured illuminator can also be matrix addressed, using the mesas to create the logical ‘rows’ of the array and ganging together bars to create common columns. As with the other array, an insulating layer can provide the cross-overs required for full matrix addressing. 20 pins can also address the 100 elements of the light source, allowing for the use of a compact package for system integration. A schematic of the pattern is shown in FIG. 10, and a previously fabricated 10×10 LED array using the proposed architecture is shown in FIG. 11.

Chip-scale/leadless packages from Amkor or Kyocera can be used to package the LED elements. System drive can be managed digitally, using a microcontroller to create a pattern that is synchronized with the focusing element. The LED arrays can be connected to a low power miniature microcontroller with a high pin count (e.g. the STM32F4, which offers enough I/O pins to drive two LED chips in a 3×3 mm micro-BGA package, offering enough voltage and current drive per output to directly power the system LEDs). This microcontroller can be triggered over the 120 bus coordinated by the image capture card, which sets the overall system timing and coordinate the illumination sequence and capture trigger.

System Characteristics and Efficiency:

LEDs offer a high efficiency, typically converting approximately 25% of the applied energy into useable light. The peak power that can be applied to GaN LEDs exceeds 100 W/cm², allowing for significant headroom in the peak available optical power in the system, and allowing for direct addressing of the individual elements from the microcontroller device. Peak micro-LED powers of 24 mW can be driven directly from the microcontroller, allowing for direct drive of the array elements using a passive matrix sequence addressing using a time multiplexed Charlieplexing approach.

To maintain a desirable system size, a custom interposer package can be fabricated for LED integration, in order to further decrease the package perimeter and format. The LED wafer thickness can also be further decreased; laser processing can be used to separate the LED layer from the substrate. Heatsinking can be added to the package structure if thermal limits an issue in a particular implementation.

The systems and methods of this implementation can provide for 3D imaging of tissue in vivo, for example, in an anesthetized animal, or even in a freely moving animal, e.g., engaged in some task that stimulates the tissue to be imaged. While the present inventors describe imaging of neural tissue, specifically brain tissue, the person of ordinary skill in the art will appreciate that the systems and methods described herein can be used in the imaging of a variety of tissue types.

The methods and systems described herein can provide closed-loop modulation of neural circuits in the context of cortical representation in awake, behaving animals. For example, imaging of brain tissue in awake, freely moving animals engaged in a basic visual discrimination task can provide a wealth of information regarding mapping of neural circuitry involved in the vision system. Use of a larger array can provide for a larger mapping of cortical functional connectivity.

Neural Transducers:

To establish an optical interface with cortex, a variety of optical neural transducers can be used. One example is the use of viral-vector mediated expression of a genetically encoded calcium indicator, jRCaMP1a, and a light-sensitive opsin protein, channelrhodopsin (ChR2). See Dana, H. et al. Sensitive red protein calcium indicators for imaging neural activity. Elife 5, doi:10.7554/eLife.12727 (2016); Zhang, F., Wang, L.-P., Boyden, E. S. & Deisseroth, K. Channelrhodopsin-2 and optical control of excitable cells. Nat. Methods 3, 785-792, doi:10.1038/nmeth936 (2006), each of which is hereby incorporated herein by reference in its entirety for all purposes and specifically for their teachings regarding these transducers. In order to achieve selective imaging of neural activity and stimulation, these selected indicators have non-overlapping excitation wavelengths, with ChR2 activated at 488 nm, and jRCaMP1a excited at 530 nm; when using other indicators, it can be desirable to have non-overlapping wavelengths. A Ca²⁺ indicator is a desirable neural activity transducer due to the relatively high signal-to-noise ratio, as compared to voltage sensitive dye or metabolically linked autofluorescence, and temporal dynamics capable of capturing single action potentials, unlike intrinsic signal imaging modalities. The calcium indicator jRCaMP1a was recently developed and has 8-fold greater sensitivity for calcium than the more commonly used red-shifted indicator, RCaMP1h (which itself can be used in other embodiments). In addition, jRCaMP1a does not exhibit photoswitching, making it compatible for use in combination with light delivery for optogenetics. To achieve optogenetic activation of particular neurons with light, one can express channelrhodopsin 2 (ChR2-EYFP) in pyramidal neurons.

To characterize the optical performance of the system of this implementation in vivo, modulation and imaging of the primary visual cortex of the lightly anesthetized mouse can be performed. The red calcium sensor jRCaMP1a and the optogenetic activator ChR2-YFP can be expressed in pyramidal cells of adult mice through transfection with AAV2, under the promoter Syn. Mice can be anesthetized for surgical procedures (1.5% isoflurane), a craniotomy can be performed over VI, and a glass window and headbar can be secured with dental cement. During imaging experiments, mice can be lightly anesthetized (0.5-1% isoflurane and xylazine) to maintain visual responsiveness. Initial experiments can be performed under a two-photon (2P) microscope with two-color PMT detection, allowing detailed evaluation of the expression of ChR2 and jRCaMP1a. Immediately following 2P imaging, the system of this implementation can be connected to a surgically-implanted head mount, and tethered to the power supply and a PC computer with a controller and an image acquisition board. For all experiments, the number of neurons imaged within the field of view, the maximum imaging depth and the responsiveness and orientation selectivity of the neurons can be characterized in V1. Stimulation of specific subsets of neurons in the 3D volume can be achieved by modifying the holographic SLM wide field microfiber stimulation method of Emiliani and co-workers (see Szabo, V., Ventalon, C., De Sars, V., Bradley, J. & Emiliani, V. Spatially selective holographic photoactivation and functional fluorescence imaging in freely behaving mice with a fiberscope. Neuron 84, 1157-1169, doi:10.1016/j.neuron.2014.11.005 (2014), hereby incorporated herein by reference in its entirety for all purposes) by targeting specific volumes for light stimulation using 488 nm micro LED stimulation in the electrowetting lens microscope. The axial and lateral resolution of stimulation can be characterized in neurons co-expressing ChR2 and jRCaMP1a by measuring calcium transients in a given neuron as small illumination spots are systematically surveyed at varying distances from the cell soma. Additionally, light intensity can be varied to determine the activation threshold. While the experiment described above uses the jRCaMP1a calcium indicator, another alternative is the use of GCaMP6s, expressed with ChR2 with modulation the illumination power to differentially image and stimulate.

Neuronal response to visual feature stimulation has been thoroughly studied in awake behaving mice in surgically-accessible V1. Recent studies have highlighted the importance of brain state in determining the firing characteristics of neurons involved in visual representation. In head-fixed animals, locomotion activates cortical VIP interneurons, which inhibit somatostatin interneurons, leading to increased excitation of pyramidal cells. Likewise, arousal can modulate visual cortex excitability and improve signal processing. However, this circuit has been explored entirely in head-fixed animals running on rotating platforms. It is not clear how the restraint of naturalistic behavior, and potential increases in anxiety that result, may affect neural circuits and the brain's neuromodulatory state. Notably, the implementation described here can be provided in a package small enough to be mounted on an animal without restriction of motion. As another example of an imaging experiment, one can investigate the effect of locomotion on cortical neuron firing in V1 in free-ranging animals. For example, mice can have a head mount surgically implanted, and then can be connected system of this implementation, and allowed to freely roam in a small, plexiglass box placed in a darkened room. An LCD monitor can be placed along one wall of the cage, and a dim red light can provide illumination for an overhead camera that can track the mouse's position and orientation of the head. Mice can be trained to a very simple discrimination task, structured as a two-alternative force choice task, with a high-contrast stationary grating stimulus covering either the top or bottom third of the monitor. Water-deprived animals can be trained to trigger stimulus presentation by entering a defined location in the middle of the cage, and associate the location of the grating with water delivery to a port at either the right or left of the monitor. Once the animal has learned the task and can achieve a high level of correct responses, the effect of locomotion on V1 firing rate can be determined. During trials when the mouse's head is oriented towards the LCD monitor, the firing rate of neurons during presentation of the visual stimulus while the animal is engaged in locomotion can be compared the stimulus-associated firing rate while the animal is quietly resting. In a second set of experiments, one can map the neurons that differentially participate during sensory perception of the top as compared to the bottom stimulus. Then, by stimulating specific neurons engaged by one of the stimuli (i.e., ‘top’ stimulus), one can investigate the biasing of the animal's visual perception, through measurement of the correct choice of water spout (right/left). Following demonstration of the ability to bias the animal's choice, one can modify the number of neurons that are stimulated to determine a minimum threshold to achieve behavioral choice bias. Control experiments can be performed with animals transduced with AAV2 expressing EYFP (no ChR2).

Novel surgical protocols developed over many years allows for routine instrumentation of a larger mammalian brain (e.g., of a human, or of another primate such as a macaque) on a large-scale with a “brainport,” allowing the installation of a system as described herein sub-durally in a semi-chronic platform. This platform means that the system can be replaced as frequently as daily or left in place chronically for any interval, extending months. An MR-based CAD workflow can be used to design and precisely-implant assemblies custom-fit to the shape of a given animal's brain and skull. The implantable brainport has defined biotic and abiotic spaces with pressure and temperature sensors to deliver detailed performance and power data for all prototype testing. The assemblies provide long-term access to healthy cortical tissue in each animal, reducing animal testing costs.

In one experiment, the periarcuate gyrus of the prefrontal cortex can be imaged while optogenetically stimulating the lateral bank of the posterior parietal cortex. When one stimulates the parietal cortex with short duration, <5 ms, light pulses one can record the responses of individual neurons in response to each light pulse. This neuronal response is robust and visible electrically and optically, as well as in the form of an fMRI response when performing opto-fMRI. One can use the stimulation response as a signal and apply signal detection theoretic tools to define the detectability and discriminability of the response compared against high-power 2p-imaging and 1p-stimulation. Detectability can be determined using the device in imaging mode. Neurons expressing C1V1 in posterior parietal cortex can be stimulated using a high-power, 50 mW, fiber-coupled laser while simultaneously imaging the response in the periarcuate gyrus. To assess imaging detectability, one can compare the light intensity levels necessary to drive a response measured by the system of the disclosure with the light intensity levels necessary to drive a response measured using a 2p-MIMMS microscope powered by a Chameleon Ultra II. Once a threshold detection is obtained, the discriminability of the different responses can be measured as the location stimulated in the parietal cortex is varied. Experiments can also be performed in stimulation mode. Neurons in the periarcuate gyrus can be imaged using a 2p-MIMMS scope while optogenetically stimulating neurons expressing C1V1 in posterior parietal cortex. To assess stimulation detectability, the light intensity necessary to drive a measurable response in the periarcuate gyrus can be compared with light intensity necessary using a fiber-coupled laser.

The methods and systems described here can allow for stimulation and imaging in the mammalian cortex. In comparison to 2P imaging, there may be shallower z-axis resolution, but a considerably larger field of view, producing an increased number of neurons that can be imaged or stimulated simultaneously.

### CONCLUSION

The techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for”, but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A system for modulation and imaging of tissue, the system comprising:
a lens system comprising one or more lenses configured to focus optical radiation conducted therethrough in an input direction along a beam path at a focal surface (e.g., focal plane) in the tissue, the lens system being configured to provide axial scanning such that the focal surface can be scanned axially with respect to the beam path to provide a plurality of focal surfaces at different focal lengths from the lens system;
a source of patterned optical radiation of an optogenetic wavelength, the optical radiation of the optogenetic wavelength being configured to modulate a property of the tissue, the source of patterned optical radiation of the optogenetic wavelength being addressable to provide a plurality of different patterns of patterned optical radiation, the system being configured to conduct optical radiation from the source of patterned optical radiation of the optogenetic wavelength through the one or more lenses in the input direction along the beam path to be focused at the focal surface;
a source of patterned optical radiation of a imaging wavelength, the source of patterned optical radiation of the imaging wavelength being addressable to provide a plurality of different patterns of patterned optical radiation, the system being configured to conduct optical radiation from the source of patterned optical radiation of the imaging wavelength through the one or more lenses along the beam path to be focused at the focal surface, the optical radiation of the imaging wavelength being configured to cause an optical signal to be emitted from the tissue from the focal surface, the optical signal being in the form of patterned optical radiation;
an image detector configured to receive the optical signal emitted from the tissue, the system being configured to conduct the optical signal emitted from the tissue at the focal surface through the lens system in an output direction along the beam path to be focused on the image detector.

2. The system according to claim 1, wherein one or more of the lenses of the lens system is an axially-tunable electrowetting lens.

3. The system according to claim 1, wherein the source of patterned optical radiation of the optogenetic wavelength is a light emitting diode (LED) array

4. The system according to claim 1, wherein the source of patterned optical radiation of the imaging wavelength is a light emitting diode (LED) array.

5. The system according to claim 1, further comprising a beam splitter that is configured to (a) receive optical radiation from the source of patterned optical radiation of the optogenetic wavelength and transmit it along the beam path through the one or more lenses of the lens system; (b) receive optical radiation from the source of patterned optical radiation of the imaging wavelength and transmit it along the beam path through the one or more lenses of the lens system; and (c) receive optical radiation along the beam path from the lens system and transmit it to the image detector.

6. The system according to claim 1, further comprising a processor operatively coupled to the image detector and configured to perform image processing.

7. The system according to claim 6, wherein the system is configured to, at a single optogenetic illumination pattern and focal position, acquire at least three images at at least three different patterns of radiation of imaging wavelength, and wherein the image processing includes performing computational processing (e.g., structured illumination microscopy processing) to provide a single processed image from the at least three acquired images to reduce background noise.

8. The system according to claim 1, provided in array form, in which a plurality of lens systems, each with its own associated pair of sources and detector, can be integrated into an array.

9. The system according to claim 1, configured to record large-scale bi-directional neural interfaces.

10. The system according to claim 1, configured to image calcium transients from a volume of tissue.

11. The system according to claim 1, wherein one or more of the lenses of the lens system is an axially-tunable electrowetting lens; the source of patterned optical radiation of the optogenetic wavelength is a light emitting diode (LED) array; and the source of patterned optical radiation of the imaging wavelength is a light emitting diode (LED) array.

12. The system according to claim 11, further comprising a processor operatively coupled to the image detector and configured to perform image processing, wherein the system is configured to, at a single optogenetic illumination pattern and focal position, acquire at least three images at at least three different patterns of radiation of imaging wavelength, and wherein the image processing includes performing computational processing (e.g., structured illumination microscopy processing) to provide a single processed image from the at least three acquired images to reduce background noise.

13. The system according to claim 1, packaged in an enclosure that is no larger than 5 cm×5 cm×5 cm.

14. A method for modulation and imaging of tissue, the method comprising:
conducting patterned optical radiation of an optogenetic wavelength in an input direction along a beam path through a lens system comprising one or more lenses, thereby focusing the optical radiation at a focal surface (e.g., focal plane) in the tissue to modulate the tissue;
conducting patterned optical radiation of a imaging wavelength through the lens system along the beam path in the input direction, thereby focusing the optical radiation at the focal surface (e.g., focal plane) in the tissue, the patterned optical radiation causing an optical signal to be emitted from the tissue from the focal surface, the optical signal being in the form of patterned optical radiation;
conducting the optical signal from the tissue along the beam path in an output direction through the lens system to be focused on an image detector; and
detecting the optical signal using the image detector.

15. The method of claim 14, further comprising changing one or more of (a) the pattern of the patterned optical radiation of the optogenetic wavelength, (b) the pattern of the patterned optical radiation of the imaging wavelength, and (c) the focal length from the lens system of the focal surface, then repeating each conducting step and the detecting step.

16. The method of claim 14, wherein the method includes obtaining a plurality of images at a plurality of lens system focal lengths.

17. The method of claim 14, wherein the imaging wavelength is configured to selectively cause a fluorescence emission from the tissue, and wherein the optical signal is a fluorescence signal.

18. The method of claim 14, wherein the imaging wavelength is configured to cause selective absorption in the tissue, and wherein the optical signal is provided by radiation of the imaging wavelength not absorbed.

19. The method of claim 14, wherein one or more of the lenses of the lens system is an axially-tunable electrowetting lens; the source of patterned optical radiation of the optogenetic wavelength is a light emitting diode (LED) array; and the source of patterned optical radiation of the imaging wavelength is a light emitting diode (LED) array.

20. The method of claim 14, comprising, at a single optogenetic illumination pattern and focal position, acquire at least three images at at least three different patterns of radiation of imaging wavelength, and performing computational image processing (e.g., structured illumination microscopy processing) to provide a single processed image from the at least three acquired images to reduce background noise.
